(19) United States
(12) Patent Application Publication
(10) Pub. No.: US 2024/0168890 A1
(43) Pub. Date: May 23, 2024

(54) Technology For Retaining Data In Cache Until Read

(71) Applicant: Intel Corporation, Santa Clara, CA (US)

(72) Inventors: Chitra Natarajan, Queens Village, NY (US); Aneesh Aggarwal, Portland, OR (US); Ritu Gupta, Cupertino, CA (US); Niall Declan McDonnell, Limerick LK (IE); Kapil Sood, Portland, OR (US); Youngsoo Choi, Alameda, CA (US); Asad Khan, Chandler, AZ (US); Lokpraveen Mosur, Gilbert, AZ (US); Subhiksha Ravisundar, Gilbert, AZ (US); George Leonard Tkachuk, Phoenix, AZ (US)

(21) Appl. No.: 18/058,401

(22) Filed: Nov. 23, 2022

(51) Int. Cl. G06F 12/12

(52) U.S. Cl. CPC G06F 12/12; G06F 2212/1021

(57) ABSTRACT

A processor package comprises a caching agent that is operable to respond to a first sequence of direct-to-cache (DTC) write misses to a partition in a set in a cache by writing data from those write misses to the partition. When the partition comprises W ways, the caching agent is operable to write data from those write misses to all W ways in the partition. After writing data from those write misses to the partition, and before any data from the partition in the set has been read, the caching agent is operable to receive a second sequence of DTC write misses to the partition, and in response, complete those write misses while retaining the data from the first sequence in at least W-1 of the ways in the partition. Other embodiments are described and claimed.

### TECHNICAL FIELD

The present disclosure pertains in general to data processing systems and in particular to technology for retaining data in cache until it has been read.

### BACKGROUND

To handle input/output (IO) traffic in network communications, a data processing system may use the technology from Intel Corp. known as “Intel® Data Direct I/O Technology” or “Intel® DDIO.” For instance, when a network interface controller (NIC) in such a data processing system receives incoming data, the NIC may use Intel® DDIO to write that data directly to cache in the data processing system, thereby avoiding costly writes to and reads from memory. Other types of data processing systems may use other technologies to allow NICs or other components to write directly to cache. For purposes of this disclosure, any IO that is written directly to cache may be referred to in general as “direct to cache” (DTC) IO. Likewise, the term “DTC” may be used in general to refer to Intel® DDIO and to similar technologies from other suppliers.

Oftentimes, DTC IO is first in first out (FIFO) in nature. For instance, when a producer such as a NIC writes a sequence of IO data items to the cache, oftentimes the consumer (e.g., a processing core) will read those items in the same order as that in which they were written.

However, a data processing system may include a caching agent that uses a least recently used (LRU) algorithm or a pseudo-LRU (PLRU) algorithm to manage cache. Such algorithms or policies tend to keep recently used data in the cache. Consequently, such policies may be well suited for temporal reuse traffic. However, such policies may not be well suited to handle data traffic of a FIFO nature. For instance, if the cache is too small to hold all of the IO data supplied by the producer before the consumer begins reading that data, as the producer keeps writing data to the cache, the PLRU policy may cause the writes to wrap around the cache and overwrite some or all of the data that has not yet been read by the consumer. Consequently, some or all of the data from the producer may be evicted from the cache to memory before it has been read by the consumer. In other words, the consumer may get relatively few or no cache hits when the cache is too small to hold the data for the time between write and read.

### BRIEF DESCRIPTION OF THE DRAWINGS

Features and advantages of the present invention will become apparent from the appended claims, the following detailed description of one or more example embodiments, and the corresponding figures, in which:

FIG. 1 is a block diagram depicting an example embodiment of a data processing system with technology for implementing a cache management policy that is suited to handle traffic of a FIFO nature.

FIG. 2 presents a state diagram illustrating various states and state transitions for one of the state machines in the caching agent of FIG. 1.

FIGS. 3A-3B present a flowchart of an example process for implementing a cache management policy that is suited to handle traffic of a FIFO nature.

FIG. 4 is a block diagram depicting an example embodiment of an IO cache with partitions that include respective staging ways.

FIG. 5 illustrates an example computing system.

FIG. 6 illustrates a block diagram of an example processor and/or System on a Chip (SoC) that may have one or more cores and an integrated memory controller.

FIG. 7 is a block diagram illustrating both an example in-order pipeline and an example register renaming, out-of-order issue/execution pipeline according to examples.

FIG. 8 is a block diagram illustrating both an example in-order architecture core and an example register renaming, out-of-order issue/execution architecture core to be included in a processor according to examples.

FIG. 9 illustrates examples of execution unit(s) circuitry.

FIG. 10 is a block diagram of a register architecture according to some examples.

### DETAILED DESCRIPTION

When compared with IO technology which sends writes to memory, DTC IO may deliver lower latency of access, reduced interconnect and memory bandwidth usage, and reduced power usage by placing data directly in the cache hierarchy instead of requiring the data to first go through the memory. These benefits may be realized by central processing units (CPUs) and systems on chips (SoCs) with large monolithic dies with large caches that are shared across cores and IO, and also by architectures with disaggregated dies with separate smaller caches in core dies and in IO dies.

As indicated above, a PLRU cache management policy may lead to sub-optimal performance for traffic that is FIFO in nature, such as DTC IO. Typically, a DTC IO workload has a circular data buffer which is written and read by both IO components (such as a NIC, an infrastructure processing unit (IPU), or an accelerator) and processing cores in a FIFO manner. This pattern of processing networking packets is significantly different from the temporal reuse and locality characteristic of core-bound compute traffic for applications such as machine learning, artificial intelligence (AI), databases, etc. Cache partitioning may be used to separate out ways for DTC IO traffic versus core compute/temporal reuse traffic. However, the same PLRU cache management policy may be used across the entire cache. For instance, the caching agent may use a PLRU cache management policy that uses two status bits to denote four different ages, and that policy may be referred to as “PLRU with 2-bit (2b) quad age.” A data processing system may include a large last level cache that is shared across all cores and IO components. Such a cache may be referred to as an “aggregated/monolithic large last level cache.” A caching agent may create a partition in that cache for DTC IO traffic. Such a partition may be referred to as a “DTC IO partition.” If the DTC IO partition is large enough (e.g., if it includes a sufficient number of ways), the PLRU cache management policy may handle the DTC IO traffic well enough.

However, if the DTC IO partition is not large enough to hold all of the data that a producer (e.g., a NIC or an accelerator) writes to the partition before a consumer (e.g., a processing core or another accelerator) reads the data, the producer may end up overwriting data in the cache before the consumer has had a chance to read it. In other words, if the DTC IO partition is undersized, the producer may end up overwriting data in that partition before the consumer has had a chance to read that data. Moreover, such overwrites will cause the overwritten data to be written to memory, to subsequently be read back from memory, thereby reducing or eliminating the benefit of writing the data directly to the cache in the first place.

According to Little's Law, the average number of items “L” in a queuing system equals the average arrival rate “A” of items to the system, multiplied by the average waiting time “W” of an item in the system. In other words, L=A*W. Accordingly, if the cache partition size (L) is smaller than that required for the desired bandwidth (data arrival rate A) given the produce-to-consume latency (waiting time W) on the system, then IO data written into a cache partition is likely to get evicted from that cache partition (and replaced with new IO writes) before the original IO data has been read.

Furthermore, a data processing system may include a processor package with disaggregated dies, possibly including one or more IO dies that each have their own IO caches. Such IO caches may be used not only for DTC traffic that is FIFO in nature (e.g., NIC traffic) but also by components which may have more of a temporal locality behavior, such as CPU IO stack components such as IO memory management units (IOMMUs) or features that enable virtualization of IO resource, on-CPU accelerators, or other agents which may use, for example, the interconnect known by the name or trademark of “Compute Express Link” (CXL). Consequently, a data processing system with a disaggregated die architecture may feature separate smaller caches in processing cores and in IO dies, yet that data processing system may be required to handle a mix of traffic, including some traffic with FIFO behaviors and other traffic with temporal reuse behaviors. In particular, the disaggregated IO caches may be used to hold a mix of traffic, including some traffic with FIFO behaviors and other traffic with temporal reuse behaviors. Hence, the same issue discussed above with monolithic large caches shared across IO and cores, such as undersized cache partition for FIFO traffic, is also applicable to disaggregated IO caches in a processor package with a disaggregated architecture.

The present disclosure describes a caching agent which implements a cache management policy that is suitable for FIFO traffic, in that it may prevent data from being evicted from the cache when that data has not yet been read by the consumer, even though the cache is full and yet the producer is still providing more data. In other words, the cache management policy provides for FIFO traffic retention (FTR). Accordingly, for purposes of this disclosure, this type of cache management policy may be referred to as an “FTR policy.” In particular, as described in greater detail below, the cache management policy provides for the aging of cache ways that contain DTC data, and for retaining the data until the data has been read or until the way containing the data has reached a predetermined maximum age.

By implementing an FTR policy, the caching agent may prevent new lines from replacing old lines before they have been read by a consumer, thereby providing a chance for old lines to be read after a longer latency from fill than that covered by the cache size for a given bandwidth. Consequently, the FTR policy may enable the caching agent to realize at least some of the cache hit benefits of DTC IO. By contrast, in an undersized cache scenario, DTC IO into cache (or a cache partition) that is managed with the traditional PLRU policy may produce no cache hit benefits.

Additionally, the caching agent may divide the cache into multiple partitions, and the caching agent may use different caching algorithms for different partitions. For instance, the caching agent may divide the cache into one or more PLRU partitions and one or more FTR partitions, the caching agent may use a PLRU algorithm to manage the PLRU partitions, and the caching agent may use an FTR algorithm to manage the FTR partitions.

For purposes of this disclosure, all of the ways in all of the sets of a cache which belong to a particular partition are collectively referred to as a “global partition.” In addition, depending on context, the term “partition” may be used to refer to a global partition or to the portion of a global partition that resides in a cache set. For instance, the phrase “partition in a set” may be used to refer to the portion of a global partition that resides in a set. Similarly, all of the ways in a particular set which belong to the same global partition may be referred to collectively as a “partition.”

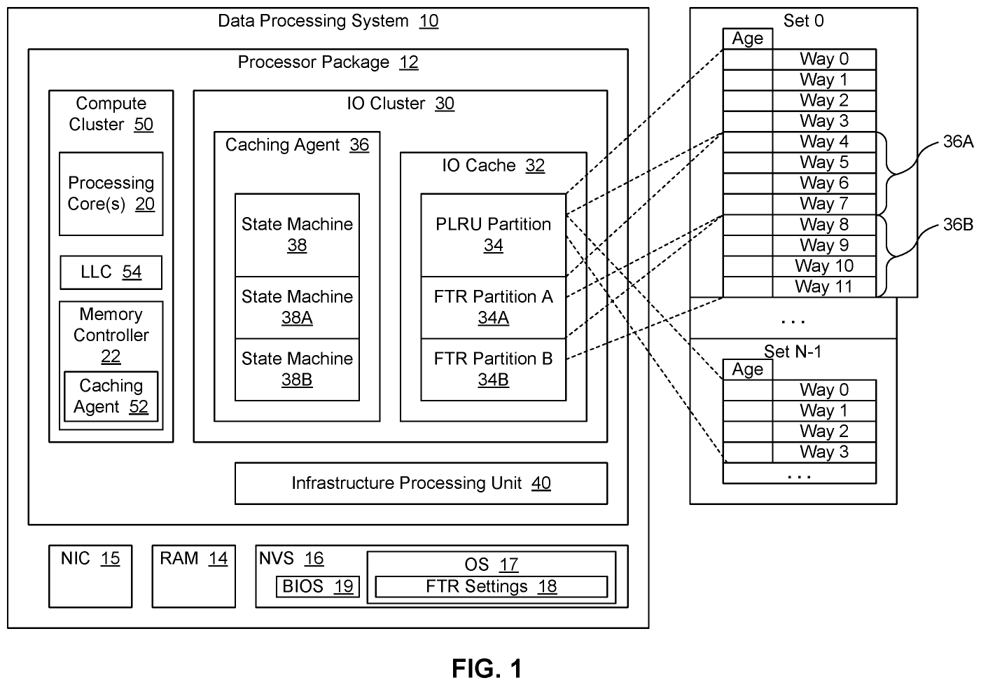

FIG. 1 is a block diagram depicting an example embodiment of a data processing system 10 with technology for implementing a cache management policy that is suited to handle traffic of a FIFO nature. That technology may include a caching agent 36 which uses one or more state machines to implement an FTR policy for cache management. In the embodiment of FIG. 1, caching agent 36 resides in an IO cluster 30 within a processor package 12 in data processing system 10. For instance, processor package 12 may be a multi-die package, IO cluster 30 may reside in one of those dies, such as an IO die, and other dies in the package may include one or more compute clusters 50. A compute cluster may also be referred to as a “core cluster” or a “compute building block” (CBB).

In the embodiment of FIG. 1, compute cluster 50 includes one or more processing cores 20 and a memory controller 22. Compute cluster 50 also includes one or more levels of cache, including a last level cache (LLC) 54 that is shared by the processing cores in compute cluster 50. Compute cluster 50 also includes a caching agent 52 which manages LLC 54. Thus, LLC 54 (and caching agent 52) is separate and distinct from IO cache 32 (and caching agent 36). Consequently, the architecture of processor package 12 may be referred to as “disaggregated.”

In the embodiment of FIG. 1, caching agent 52 resides in memory controller 22. Processor package 12 may also include an IPU 40, either as a separate die or as part of one of the other dies. In some embodiments or scenarios, caching agent 52 may use an FTR policy to manage one or more FTR partitions in LLC 54.

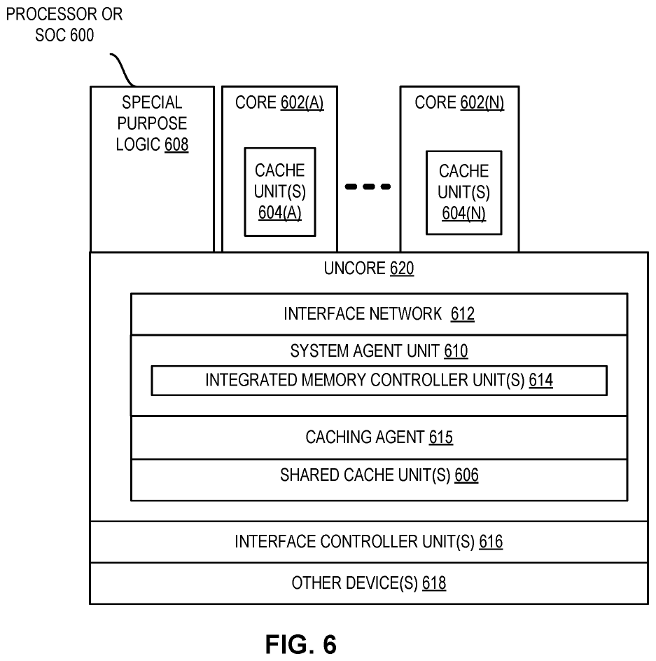

In an alternative embodiment, a processor package includes one or more processing cores, one or more IO units, and a monolithic uncore. The uncore includes a cache cluster with a large monolithic cache that is shared across all of the cores and IO units. The uncore also includes a caching agent which uses an FTR policy to manage one or more FTR partitions in the large monolithic cache. A processor package with such a caching agent is described in greater detail below (e.g., with regard to FIG. 6).

In the embodiment of FIG. 1, data processing system 10 also includes various components that are coupled (directly or indirectly) to processor package 12. Those components include random access memory (RAM) 14, a NIC 15, and nonvolatile storage (NVS) 16. NVS 16 may include software such as a basic input/output system (BIOS) and an operating system (OS) 17. NVS 16 may also include FTR settings 18 that specify various aspects of the FTR policy to be used by caching agent 36. Some or all of the FTR settings 18 may be supplied to caching agent 36 by OS 17 and/or BIOS 19. In addition or alternatively, some or all of the FTR settings 18 may be supplied to caching agent 36 by an external provider, such as an out-of-band (OOB) management agent.

In addition to caching agent 36, IO cluster 30 also includes an IO cache 32. Caching agent 36 may configure IO cache 32 according to various cache configuration settings, such as FTR settings 18, some or all of which may reside in any suitable location or locations within (or outside of) data processing system 10, as indicated above. IO cluster 30 may also include one or more accelerators and a home agent/memory controller. In an alternative embodiment, one or more accelerators and/or a home agent/memory controller reside in one or more compute clusters.

In one embodiment or scenario, FTR settings 18 specify the number and type of global partitions to be implemented or instantiated within IO cache 32. In particular, FTR settings 18 may specify how many global pseudo-LRU (PLRU) partitions are to be instantiated and how many global FTR partitions are to be instantiated. FTR settings 18 may also specify how many ways are to be assigned to each partition. Caching agent 36 may configure IO cache 32 to include one or more global PLRU cache partitions and one or more global FTR cache partitions, according to FTR settings 18.

In the embodiment of FIG. 1, caching agent 36 has configured IO cache 32 to have one global PLRU partition 34 and two global FTR partitions, illustrated as FTR partition A 34A and FTR partition B 34B. In addition, FIG. 1 uses dashed lines to show which ways in set 0 are assigned to which global partition. Caching agent 36 also assigns corresponding ways in each of the other sets to corresponding global partitions.

In the embodiment of FIG. 1, caching agent 36 has configured IO cache 32 as a 12-way set associative cache with N sets (depicted in FIG. 1 as Set 0-Set N−1). And as indicated with dashed lines, caching agent 36 has partitioned the ways in each set so that PLRU Partition 34 uses ways 0-3, FTR Partition A uses ways 4-7, and FTR Partition B uses ways 8-11. Thus, FTR partition A includes a group 36A of four ways, and FTR partition B includes a different group 36B of four ways. However, in other embodiments or scenarios, a caching agent may use other types and numbers of partitions. For instance, a caching agent may configure an IO cache with one PLRU partition and one FTR partition, and the caching agent may assign any suitable number of ways to each partition.

In addition, each line (or way) in each FTR partition is associated with (or is connected to, or contains) status bits which serve as an age attribute, and the caching agent does not evict a line (or way) from the cache until that line (or way) has either been read or has reached a maximum age. In addition, for PLRU partitions, caching agent may use those two status bits to denote four different ages for a cache management policy such as PLRU with 2b quad age. In the embodiment of FIG. 1, the age attributes for the ways are illustrated as a column to the left of the ways.

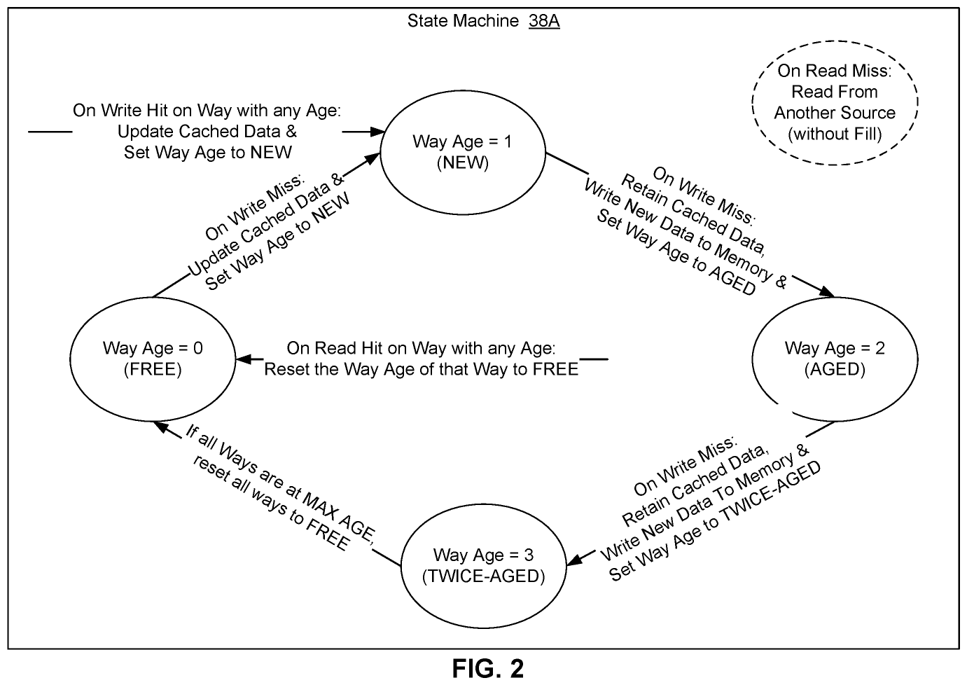

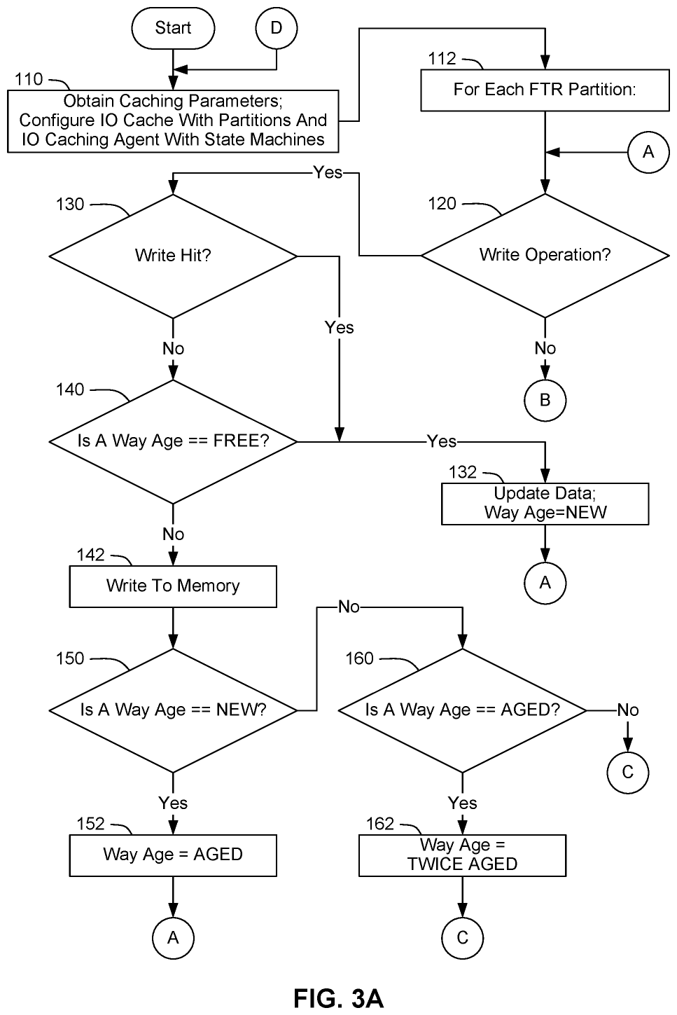

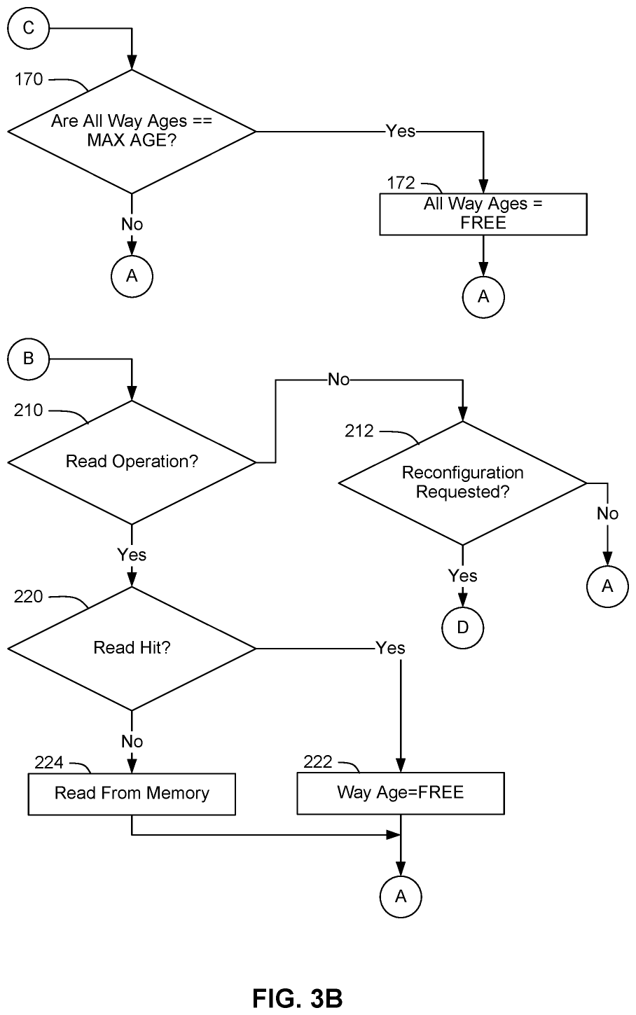

Also, caching agent 36 may use a different state machine to manage each partition. For instance, caching agent 36 may use state machine 38 to manage PLRU partition 34, state machine 38A to manage FTR partition A, and state machine 38B to manage FTR partition B. Additionally, the age attributes (or simply “ages”) of each way in a partition may be part of a state machine for that partition. In particular, caching agent 36 uses a state machine to manage the age attributes for each FTR partition according to a predetermined policy or algorithm. Such a state machine, and a process for implementing such a policy or algorithm, are described below respectively, with regard to FIGS. 2 and 3A-3B.

FIG. 2 presents a state diagram illustrating various states and state transitions for state machine 38A. In the embodiment of FIG. 2, caching agent 36 uses state machine 38A to implement an FTR cache management policy that provides for a maximum age or “max age” of TWICE-AGED. However, in other embodiments or scenarios, a caching agent may use a different max age, such as ONCE-AGED (or simply AGED). Also, for the purpose of illustration, state machine 38A shows states and state transitions for an example way within an example set within FTR partition A. However, state machine 38A may actually include states and state transitions for all of the ways within all of the sets within FTR partition A.

FIGS. 3A-3B present a flowchart of an example process for implementing a cache management policy that is suited to handle traffic of a FIFO nature. Caching agent 36 may use the process of FIGS. 3A-3B to, for instance, realize the states and state transitions depicted in FIG. 2. As shown at block 110, the process of FIG. 3A may start with caching agent 36 obtaining caching parameters and configuring IO cache 32 and associated state machines accordingly. The caching parameters may include FTR settings 18. FTR settings 18 may specify parameters such as the number of FTR partitions to create, the number of ways for each FTR partition, the max age for each partition, etc. FIGS. 3A-3B focus on an embodiment or scenario involving a max age of TWICE-AGED. However, in other embodiments or scenarios, caching agent 36 may use a different max age, such as ONCE-AGED (or simply AGED).

In an example scenario, FTR settings 18 specify that IO cache 32 is to include a PLRU partition with four ways and two FTR partitions with 4 ways each, and that the max age for each FTR partition is to be TWICE-AGED. Accordingly, at block 110, caching agent 36 configures IO cache 32 with PLRU partition 34 and FTR partitions A and B, and caching agent instantiates respective state machines 38, 38A, and 38B. And when instantiating the FTR state machines (e.g., state machine 38A), caching agent 36 may initialize the age of each way in the partition to FREE (which may be represented by the value 0, for instance). Caching agent 36 may then wait for read or write operations involving any of the partitions, as shown at block 112. For the purpose of illustration, the description below focuses on operations involving set 0 in FTR partition A. However, caching agent 36 may perform the same kinds of operations with the other sets in FTR partition A and with FTR partition B.

After caching agent 36 has configured IO cache 32 and the corresponding state machines, when a producer (e.g., an IO component such as a NIC or an accelerator) writes to an FTR partition, caching agent 36 may write that data into a FREE way (if one exists), while incrementing the age attribute of that way to NEW (which may be represented by the value 1, for instance). In particular, as shown at blocks 120, 130, and 132, on a write miss (“no” branch from block 130) when a way in the corresponding set in FTR partition A has the age of FREE (“yes” branch from block 140), caching agent 36 updates (or writes to) that way with the data from the IO write, and caching agent 36 updates the age of that way to NEW. In FIG. 2, those same operations are depicted by the state transition arrow that leads from the state of “Way Age=0” to the state “Way Age=1.” Also, as indicated below, when a consumer (e.g., processing core 20) reads data from a way, caching agent 36 resets the age of that way to FREE. If none of the ways in a partition in a set are FREE, that partition (i.e., the portion of the global partition which resides in that set) may be referred to as “full.”

Also, as described in greater detail below, if a producer performs a write operation when FTR partition A is full, if the write is a miss and any corresponding ways are NEW, caching agent 36 updates one of those ways to AGED (which may be represented by the value 2, for instance). However, caching agent 36 will not write the data to the cache, but will instead write the data to memory, thereby allowing older data to stay in the cache. And caching agent 36 may respond to additional write misses similarly. Furthermore, caching agent 36 may provide for a maximum age, and once all of the ways of a partition in a set have reached the maximum age, the caching agent may reset the age attribute for all of those ways to “FREE,” to prevent lines from being retained perpetually.

However, in an alternative embodiment, the caching agent implements an FTR policy by designating one of the ways in the partition of each set as a reserved way or a staging way. And when the ways in a partition in a set are full, instead of writing new data to memory, the caching agent writes the new data to the staging way for that set, thereby causing the old data from the staging way to get evicted to memory, while allowing the data in all of the other ways in the partition in the set to be retained.

However, referring again to FIG. 3A, if caching agent 36 detects a write hit to any of the ways in FTR partition A, caching agent 36 updates the data in that way with the data from the write and updates the age of that way to NEW, as shown at block 132. In FIG. 2, those same operations are depicted by the state transition arrow that leads from an unspecified state to the state “Way Age=1.” Referring again to block 132 of FIG. 3A, the process may then return to block 120 via page connector A.

However, as shown at block 142 of FIG. 3A, on a write miss when no way in the set for FTR partition A has the age of FREE, instead of writing the data from the write to FTR partition A, caching agent 36 writes the data to memory (e.g., RAM 14). In other words, when FTR partition A is full, caching agent 36 retains the data in FTR partition A, and instead of overwriting some of the data in FTR partition A with the new data, caching agent 36 writes the new data to memory. However, in another embodiment, as described in greater detail below, the caching agent may write the new data to a reserved way or staging way instead of writing the new data to memory.

Referring again to the embodiment of FIG. 3A, after writing the data to memory, caching agent 36 may determine whether FTR partition A contains any ways with the age of NEW. As shown at block 152, if there is such a way, caching agent 36 updates the age of that way to AGED, as indicated above, and the process may return to block 120 via page connector A. In FIG. 2, the state transition arrow that leads from the state of “Way Age=1” to the state “Way Age=2” also depicts the operations described above for retaining the data in the cache, writing the new data to memory, and changing the age of a way from NEW to AGED.

However, as shown at block 160, if none of the ways (in the relevant partition in the relevant set) have the age of NEW, caching agent 36 determines whether any of the ways have the age of AGED. If any of the ways has the age of AGED, caching agent 36 updates the age of one of those ways to TWICE-AGED (which may be represented by the value 3, for instance), as shown at block 162. In FIG. 2, those same operations are depicted with the state transition arrow that leads from the state of “Way Age=2” to the state “Way Age=3.”

Thus, when the partition is full, caching agent 36 ages the ways in that partition, incrementing the age of one way in the partition each time the data from a write miss gets redirected to memory (or, in an alternative embodiment, to the staging way). After caching agent 36 sets the age of a way to TWICE-AGED, the process may then pass through page connector C to FIG. 3B.

However, referring again to block 160, on a write miss, if none of the ways have the age of AGED (or FREE or NEW), then caching agent 36 may conclude that all of ways have an age of TWICE-AGED. And as indicated earlier, in the example scenario, FTR settings 18 specify a max age of TWICE-AGED. Alternatively, as shown at blocks 162 and 170, caching agent 36 may check whether all of the ways have the max age each time caching agent 36 sets one of the ways to TWICE-AGED. As shown at block 172, if all of the ways are at the max age, caching agent 36 updates the ages for all of the ways to FREE. In FIG. 2, those same operations are depicted with the state transition arrow that leads from the state of “Way Age=3” to the state “Way Age=0.”

The process of FIG. 3B may then return to block 120 via page connector A.

Also, as shown at block 120, if caching agent 36 has not received a write operation, the process may pass through page connector B to block 210, and caching agent 36 may determine whether it has received a read operation. And if caching agent 36 has received a read operation, caching agent 36 may determine whether the read hits any of the ways in FTR partition A, as shown at block 220. On a read hit, caching agent 36 may read the data from the indicated way, and caching agent may update the age of that way to FREE, as shown at block 222. Also, in FIG. 2, the operation of resetting the age of the indicated way to FREE is depicted with the state transition arrow that leads from an unspecified state to the state “Way Age=0.” Thus, whenever a consumer reads a way from FTR partition A, caching agent 36 resets the age attribute of that way to FREE.

However, referring again to block 220 of FIG. 3B, when caching agent 36 detects a read miss, caching agent satisfies the read from a source other than IO cache 32. For instance, caching agent 36 may send the read request to a home agent which may resolve the read request by reading the data from another cache or from RAM 14, as shown at block 224. Furthermore, the read request may be processed without writing the corresponding data to IO cache 32. In other words, the data does not fill into IO cache 32. Thus, for a read miss, caching agent 36 processes the read request with no fill. The process may then return to block 120 via page connector A.

Also, in FIG. 2, the dashed oval depicts the operations described above, with caching agent 36 handling a read miss by obtaining the data from another source, without filling that data into IO cache 32.

However, referring again block 210, if caching agent 36 has not received a read request, caching agent 36 may determine whether it has received a reconfiguration request, as shown at block 212. For instance, caching agent 36 may receive such a reconfiguration request from OS 17 or from an external OOB management agent. If reconfiguration has not been requested, the process may return to block 120 via page connector A. However, if reconfiguration has been requested, the process may return to block 110 via page connector D, and caching agent 36 may then modify the configuration of IO cache 32 and any corresponding state machines according to the new FTR settings or other new caching parameters associated with the reconfiguration request. Caching agent 36 may then continue to process reads, writes, and reconfiguration requests as indicated above, but in accordance with the new parameters.

However, as indicated above, in another embodiment or scenario, FTR settings 18 may specify a different max age, such as ONCE-AGED or simply AGED. In that case, caching agent 36 may perform operations like those described above but modified according to the specified max age. For instance, when max age is AGED, caching agent 36 may use a state machine like the one in FIG. 2, but without the state for “Way Age=3,” and without the state transition arrow leading to that state. And the state transition arrow that comes from “Way Age=3” (i.e., the arrow that says “If all Ways are at MAX AGE, reset all ways to FREE”) may instead come from “Way Age=2.” Similarly, caching agent 36 may perform operations like those shown in FIGS. 3A-3B, but without blocks 160 and 162, and with the process passing from the “no” branch of block 150 to block 170, with caching agent 36 determining whether all ways (in a partition in a set) are at max age in response to a write miss with no way ages (in that partition in that set) having the value of FREE or NEW.

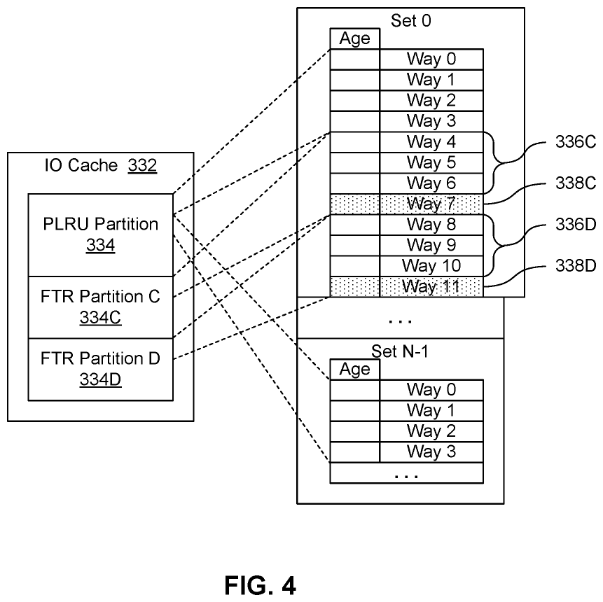

Furthermore, as indicated above, in another embodiment, the caching agent implements an FTR policy that processes a write miss to a full FTR partition by writing the new data to a predetermined staging way in the partition, rather than writing the new data to memory. In particular, when configuring the IO cache to include an FTR partition, the caching agent reserves one of the ways in each set in the FTR partition to serve as a staging way. Accordingly, the reserved way in such a partition may be referred to as the “staging way,” and the other ways in the partition may be referred to as the “regular ways.” Subsequently, when processing write operations, if the partition is full, the caching agent writes data from write misses to the staging way, instead of writing them to memory. However, the caching agent still retains the data in the regular ways until a way has been read or until all of the ways have reached the max age. For purposes of this disclosure, such a cache management policy may be referred to as an “FTR with staging policy.” Such a cache management policy may be beneficial in a data processing system that does not provide the caching agent with a mechanism or path for redirecting DTC writes to memory, or in a data processing system with a caching agent that (a) makes the decision to allocate a write into cache before the way age is known and that (b) can't then cancel the allocation and divert the new write to memory. An example embodiment of a data processing system with a caching agent that implements a cache management policy of FTR with staging is described in greater detail below with regard to FIG. 4.

FIG. 4 is a block diagram depicting an example embodiment of an IO cache 332 with FTR partitions that include respective staging ways, as used by a caching agent that implements an example cache management policy of FTR with staging. In one embodiment, IO cache 332 resides in a data processing system like the one depicted in FIG. 1, and IO cache 332 is like IO cache 32, but the caching agent has configured IO cache 332 to include a PLRU partition 334, an FTR partition C 334C, and an FTR partition D 334D, with PLRU partition 334 including ways 0-3 of each set, FTR partition C including ways 4-7 of each set, and FTR partition D including ways 8-11 of each set. In addition, the caching agent has selected or reserved way 7 to serve as the staging way 338C for each set in FTR partition C, and the caching agent has selected or reserved way 11 to serve as the staging way 338D for each set in FTR partition D. In addition, the caching agent uses ways 4-6 as regular ways 336C for FTR partition C, and the caching agent uses ways 8-10 as regular ways 338D for FTR partition D.

For the purpose of illustration, the description below focuses on operations involving set 0 of FTR partition C. However, the caching agent may perform the same kinds of operations on the other sets in FTR partition C and on FTR partition D.

When processing reads, the caching agent may operate like caching agent 36. For instance, for a read hit on any of the ways in FTR partition C, the caching agent may read the data from the indicated way and reset that way to FREE. And on a read miss, the caching agent may satisfy the read from another source (e.g., from RAM or from another cache) without writing that data to the IO cache.

When processing a write hit to any of the ways in FTR partition C, the caching agent may update the data in that way with the data from the write request, and the caching agent may update the age of that way to NEW.

And when processing a write miss involving FTR partition C, if none of the ways in the relevant set are FREE, the caching agent may write the data to the staging way for that set (e.g., staging way 338C), thereby retaining the data in regular ways for that set (e.g., regular ways 336C). And in conjunction with that write to the staging way, the caching agent may update the age of the staging way to be the max age, and the caching agent may increment the age of a regular way in that set, if any of those ways is less than the max age (starting with a NEW way, or if there are none of them, an AGED way). And when all of the ways in the set reach the max age, the caching agent may reset all of those ways to FREE.

The FTR policy illustrated in FIG. 2 and FIGS. 3A-3B may be referred to as the basic FTR policy. Compared to the basic FTR policy, the FTR with staging policy may incur additional overhead for a cache write, and it may be unable to fully utilize the staging way for retaining old FIFO data. But the FTR with staging policy still ages ways and retains data from old writes for potential DTC IO cache hit benefits.

Also, for any of the cache management policies described above, the caching agent may always use ways that are marked as INVALID as the top priority for replacement. In other words, when processing a write miss, the caching agent may always fill to an INVALID way before filling to any VALID way, without regard to the ages of the ways. Accordingly, when a way is invalidated for some reason, the caching agent may not update the age of that way to FREE (or 0), because INVALID ways will be top priority. However, if there is no INVALID way in the relevant set in an FTR partition, the caching agent may then consider the ages of the ways in that set and make decisions according to the policy set forth above with regard to FIGS. 2, 3A-3B, and 4.

For the basic FTR policy with a max age of TWICE-AGED (or 3), the meanings of the different ages may be summarized as follows:
Age=0: Line read and not important to retain, or not read and aged out, or invalid (not born yet).
   Candidate way for new fill/write to a set.
Age=1: Newly filled way (i.e., just born).
Age=2: Not read line. The older line was aged once when a new write to the way arrived and that write was sent to memory instead of replacing this way with the older line.
Age=3: Not read line. The line is twice aged when a second new write to the way arrives and is sent to memory instead of replacing this way with the older line.

Similarly, the basic FTR policy with A max age of TWICE-AGED (or 3) may be summarized as follows:
On a write fill to the FTR cache partition, if there is a way at age ′0 in the set:
   allocate into that way and update age of that way to ′1 (new line born/written).
On a write fill to the FTR cache partition, if there is no way at age ′0 and at least 1 way at age ′1 in the set:
   update the age of a chosen way at ‘1 to’2 (aged once), and send the new write to memory.
On a write fill to the FTR cache partition, if there is no way at age ′0 or ′1 and at least 1 way at ′2 in the set:
   update the age of a chosen way at ′2 to ′3 (aged twice), and send the new write to memory.
   If this update makes all ways in the set to max age, reset ages of all ways in set to 0 (auto-release long-held not read lines when the whole set reaches max age).
On a read hit in the FTR cache partition:
   update the age of the hit way to ′0 (line has been read, not important to retain, make it top candidate for new fills).
   However, if there is a core read: the line could move to the core cache and get invalidated in the FTR cache partition, or the line could be read & valid in both caches. In either case, the age in the FTR cache partition is updated to 0.

Similarly, the state transitions for the basic FTR policy may be summarized as follows:
rd_hit: from any way age, go to way age 0.
wr_hit: from any way age, go to way age 1 and update line.
rd_miss: no allocate/fill.
wr_miss: allocate and fill or go to memory as per the state machine in FIG. 2.
Max age can be set to 2 or 3, and if the DTC FTR cache partition size is undersized by up to two times or three times from that required by Little's law, the caching agent may still get greater than a zero percent hit rate.

The following example scenarios describe the performance of a caching agent under various different system configurations, each of which involves an optimum cache partition size for DTC FTR cache partition of 18 MB, according to Little's Law (throughput*latency):
Scenario 1: Actual DTC FTR cache partition partition size=12 MB
   PLRU policy:˜0% hit.
   FTR policy with max age of 2 or 3.
      First 12 MB written in DTC FTR cache partition; next 6 MB to memory; next 12 MB to DTC FTR cache partition; next 6 MB to memory; . . .
      Hit rate=12/18=66% instead of ˜0%.
Scenario 2: Actual DTC FTR cache partition size=9 MB.
   PLRU policy:˜0% hit.
   FTR policy with max age of 2 or 3.
      First 9 MB written in DTC FTR cache partition; next 9 MB to memory; following 9 MB to DTC FTR cache partition, following 9 MB: memory . . .
      Hit rate=9/18=50% instead of ˜0%.
Scenario 3: Actual DTC FTR cache partition size=6 MB.
   PLRU policy: ˜0% hit.
   FTR policy with max age 2: ˜0% hit.
   FTR policy with max age 3:
      First 6 MB written in DTC FTR cache partition; next 12 MB to memory; next 6 MB to DTC FTR cache partition; next 12 MB: memory . . .
      Hit rate=6/18=33% instead of ˜0%.
Scenario 4: Actual DTC FTR cache partition size <6 MB:
   ˜0% hit for both PLRU & FTR policy.

Table 1 below illustrates how ages change in an example scenario involving a 1-set 8-way FTR partition in an IO cache (IO$), where all the ways reach the max age of three and all the way ages get reset. This scenario is like Scenario 4 above, in that an eight-element cache provides a maximum of three times coverage with max age of three. For instance, when no read happens after 24 writes, older lines start getting replaced even though they have not been read yet. If the latency is so high that reads only happen beyond this point, there will be about a zero percent hit rate. Also, in this scenario, when there are multiple candidate ways for replacement, the caching agent chooses the lowest way number.

TABLE 1
Way age transition for first example FIFO traffic series

| way | 7 | 6 | 5 | 4 | 3 | 2 | 1 | 0 | comments |
|---|---|---|---|---|---|---|---|---|---|
| start | 0 | 0 | 0 | 0 | 0 | 0 | 0 | 0 | |
| 1^{st} write | 0 | 0 | 0 | 0 | 0 | 0 | 0 | 1 | new write to IO$ |
| 8^{th} write | 1 | 1 | 1 | 1 | 1 | 1 | 1 | 1 | new write to IO$ |
| 9^{th} write | 1 | 1 | 1 | 1 | 1 | 1 | 1 | 2 | new write to mem, 1^{st} 8 |
| | | | | | | | | | lines retained |
| 16^{th} | 2 | 2 | 2 | 2 | 2 | 2 | 2 | 2 | new write to mem, 1^{st} 8 |
| write | | | | | | | | | lines retained |
| 17^{th} | 2 | 2 | 2 | 2 | 2 | 2 | 2 | 3 | new write to mem, 1^{st} 8 |
| write | | | | | | | | | lines retained |
| 23^{rd} | 2 | 3 | 3 | 3 | 3 | 3 | 3 | 3 | new write to mem, 1^{st} 8 |
| write | | | | | | | | | lines retained |
| 24^{th} | 0 | 0 | 0 | 0 | 0 | 0 | 0 | 0 | all ways max aged; reset |
| write | | | | | | | | | all ways to age 0 though |
| | | | | | | | | | none read |

Table 2 below illustrates how ages change in an example scenario involving a 1-set 8-way FTR partition in an IO$ with a max age of two. Also, in this scenario, an IO agent starts reading the FIFO traffic writes before the full set (i.e., all ways in the set) hits max age. For instance, the read to the 1st write happens after 12 writes. Had the caching agent been using a PLRU policy, the 9th write would have replaced the 1st write, which would have resulted in a miss for the read for the 1st write. And misses would have happened for the next two reads as well, with a PLRU policy. But because the FTR policy retains the first eight lines written longer, the read now gets a hit in the FTR partition. And the reads cause the caching agent to reset the ages of the ways as they are read, enabling new writes to go into those ways rather than memory.

TABLE 2
Way age transition for second example FIFO traffic series

| way | 7 | 6 | 5 | 4 | 3 | 2 | 1 | 0 | comments |
|---|---|---|---|---|---|---|---|---|---|
| start | 0 | 0 | 0 | 0 | 0 | 0 | 0 | 0 | |
| 1^{st} write | 0 | 0 | 0 | 0 | 0 | 0 | 0 | 1 | new write to IO$ |
| 8^{th} write | 1 | 1 | 1 | 1 | 1 | 1 | 1 | 1 | new write to IO$ |
| 9^{th} write | 1 | 1 | 1 | 1 | 1 | 1 | 1 | 2 | new write to mem, |
| | | | | | | | | | 1^{st} 8 lines retained |
| 12^{th} | 1 | 1 | 1 | 1 | 2 | 2 | 2 | 2 | new write to mem, |
| write | | | | | | | | | 1^{st} 8 lines retained |
| IO read | 1 | 1 | 1 | 1 | 2 | 2 | 2 | 0 | way 0 read |
| 1^{st} write | | | | | | | | | |
| 13^{th} | 1 | 1 | 1 | 1 | 2 | 2 | 2 | 1 | new write to IO$ |
| write | | | | | | | | | writes to way 0 |
| IO read | 1 | 1 | 1 | 1 | 2 | 2 | 0 | 1 | way 1 read |
| 2^{nd} write | | | | | | | | | |
| 14^{th} | 1 | 1 | 1 | 1 | 2 | 2 | 1 | 1 | new write to IO$ |
| write | | | | | | | | | writes to way 1 |
| IO read | 1 | 1 | 1 | 1 | 2 | 0 | 1 | 1 | way 2 read |
| 3^{rd} write | | | | | | | | | |
| 15^{th} | 1 | 1 | 1 | 1 | 2 | 1 | 1 | 1 | new write to IO$ |
| write | | | | | | | | | writes to way 2 |
| 16^{th} | 1 | 1 | 1 | 1 | 2 | 1 | 1 | 2 | new write to mem, |
| write | | | | | | | | | writes 4-8 and 13-15 |
| | | | | | | | | | retained |

In some embodiments, the caching agent decides whether or not to allocate (or fill) after determining the way age. However, in other embodiments, this allocation decision may be made much earlier in the pipeline, such as based on the transaction opcode type, and the way age may be determined much later in the pipeline. In such embodiments, other implementation possibilities may be used. For example, if it is possible to cancel the decision to allocate later (e.g., after the way age is determined and it indicates no fill), the caching agent may cancel the cache allocation and send the write to memory at that point. Also, this sending of the new write to memory could be faked by substituting the new write as though an eviction happened due to allocation.

Alternatively, as indicated above, a caching agent may implement a policy of FTR with staging, with a reserved way in the cache for staging new writes to memory. Tables 3 and 4 below illustrate how the FTR with staging policy works for the scenarios illustrated above in Tables 1 and 2, respectively, with way 7 being the reserved way. As shown, the reserved way reduces the effective cache size, causing the reset to happen earlier in the example in Table 3, compared to Table 1. And one fewer line is retained at the end of the series in the example in Table 4, compared to Table 2. However, the caching agent continues to get some hits for the example Table 4, which is an improvement relative to the PLRU policy.

TABLE 3
Way age transition for first example with reserved way

| way | 7 | 6 | 5 | 4 | 3 | 2 | 1 | 0 | comments |
|---|---|---|---|---|---|---|---|---|---|
| start | 0 | 0 | 0 | 0 | 0 | 0 | 0 | 0 | |
| 1^{st} write | 0 | 0 | 0 | 0 | 0 | 0 | 0 | 1 | new write to IO$ |
| 8^{th} write | 1 | 1 | 1 | 1 | 1 | 1 | 1 | 1 | new write to IO$ |
| 9^{th} write | 3 | 1 | 1 | 1 | 1 | 1 | 1 | 2 | overwrite reserved way |
| | | | | | | | | | 7, retain old lines 0-6 |
| 10^{th} | 3 | 1 | 1 | 1 | 1 | 1 | 2 | 2 | overwrite reserved way |
| write | | | | | | | | | 7, retain old lines 0-6 |
| 15^{th} | 3 | 2 | 2 | 2 | 2 | 2 | 2 | 2 | overwrite reserved way |
| write | | | | | | | | | 7, retain old lines 0-6 |
| 18^{th} | 3 | 2 | 2 | 2 | 2 | 3 | 3 | 3 | overwrite reserved way |
| write | | | | | | | | | 7, retain old lines 0-6 |
| 22^{nd} | 0 | 0 | 0 | 0 | 0 | 0 | 0 | 0 | all ways max aged; reset |
| write | | | | | | | | | all ways to age 0 though |
| | | | | | | | | | none read |
| 23^{rd} | 0 | 0 | 0 | 0 | 0 | 0 | 0 | 0 | overwrite way 0, retain |
| write | | | | | | | | | old lines 1-6 |

TABLE 4
Way age transition for second example with reserved way

| way | 7 | 6 | 5 | 4 | 3 | 2 | 1 | 0 | comments |
|---|---|---|---|---|---|---|---|---|---|
| start | 0 | 0 | 0 | 0 | 0 | 0 | 0 | 0 | |
| 1^{st} write | 0 | 0 | 0 | 0 | 0 | 0 | 0 | 1 | new write to IO$ |
| 8^{th} write | 1 | 1 | 1 | 1 | 1 | 1 | 1 | 1 | new write to IO$ |
| 9^{th} write | 3 | 1 | 1 | 1 | 1 | 1 | 1 | 2 | overwrite reserved |
| | | | | | | | | | way 7, retain old |
| | | | | | | | | | lines 0-6 |
| 12^{th} | 3 | 1 | 1 | 1 | 2 | 2 | 2 | 2 | overwrite reserved |
| write | | | | | | | | | way 7, retain old |
| | | | | | | | | | lines 0-6 |
| IO read | 3 | 1 | 1 | 1 | 2 | 2 | 2 | 0 | way 0 read |
| 1^{st} write | | | | | | | | | |
| 13^{th} | 3 | 1 | 1 | 1 | 2 | 2 | 2 | 1 | new write to IO$ |
| write | | | | | | | | | writes to way 0 |
| IO read | 3 | 1 | 1 | 1 | 2 | 2 | 0 | 1 | way 1 read |
| 2^{nd} write | | | | | | | | | |
| 14^{th} | 3 | 1 | 1 | 1 | 2 | 2 | 1 | 1 | new write to IO$ |
| write | | | | | | | | | writes to way 1 |
| IO read | 3 | 1 | 1 | 1 | 2 | 0 | 1 | 1 | way 2 read |
| 3^{rd} write | | | | | | | | | |
| 15^{th} | 3 | 1 | 1 | 1 | 2 | 1 | 1 | 1 | new write to IO$ |
| write | | | | | | | | | writes to way 2 |
| 16^{th} | 3 | 1 | 1 | 1 | 2 | 1 | 1 | 2 | overwrite reserved |
| write | | | | | | | | | way 7, writes 4-6 |
| | | | | | | | | | and 13-15 retained |

As has been described, a processor package includes a cache and caching agent that manages an FTR partition in the cache using an FTR policy. Accordingly, the caching agent may retain data in a set of the FTR partition when that set is full and the data in the cache has not yet been read by the consumer, and yet the producer is still providing more data. Rather than replacing data in the set with the new data from the producer, the caching agent may redirect the new data to memory, or the caching agent may direct the new data to a reserved way in the set. Thus, the caching agent may receive a first sequence of DTC write operations that are write misses to a partition in a set in a cache. In response to receiving that sequence of DTC write operations, the caching agent may write the data from the first sequence of DTC write operations to the partition in the set. In one scenario, the partition in the set comprises W ways, where W is greater than two, and the first sequence of DTC write operations includes enough data to fill the partition in the set. Accordingly, the operation of writing data from the first sequence of DTC write operations to the partition in the set comprises writing data to each of the ways in the partition in the set (i.e., filling the partition in the set). Furthermore, before any data from the partition in the set has been read, the caching agent may receive a second sequence of at least two DTC write operations that are write misses to the partition in the set. In response, the caching agent may complete the second sequence of DTC write operations while retaining the data from the first sequence of DTC write operations in at least W−1 of the ways in the partition in the set. For instance, if W is eight, the caching agent may retain the data from the first sequence of DTC write operations in at least seven of those ways. For instance, the caching agent may complete the DTC write operations in the second set by redirecting the writes to memory, thereby retaining the data from the first set in all eight of the ways, or by directing all of the writes from the second set to a particular reserved way among the eight ways, thereby retaining the data from the first set in the other seven ways.

Example Computer Architectures.

Detailed below are descriptions of example computer architectures. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

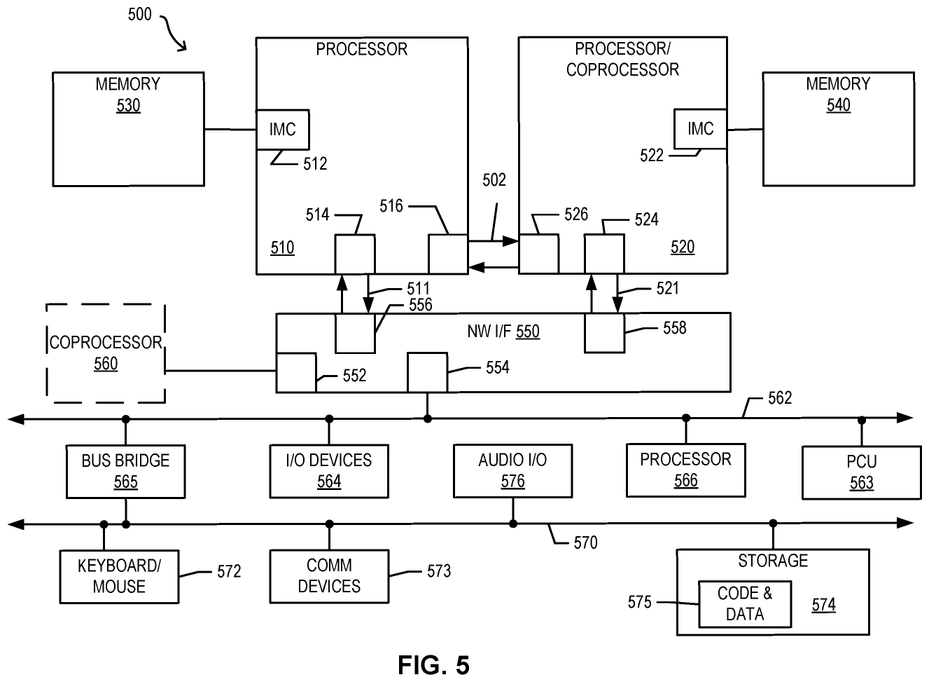

FIG. 5 illustrates an example computing system. Multiprocessor system 500 is an interfaced system and includes a plurality of processors or cores including a first processor 510 and a second processor 520 coupled via an interface 502 such as a point-to-point (P-P) interconnect, a fabric, and/or bus. In some examples, the first processor 510 and the second processor 520 are homogeneous. In some examples, first processor 510 and the second processor 520 are heterogenous. Though the example system 500 is shown to have two processors, the system may have three or more processors, or may be a single processor system. In some examples, the computing system is a system on a chip (SoC).

Processors 510 and 520 are shown including integrated memory controller (IMC) circuitry 512 and 522, respectively. Processor 510 also includes interface circuits 514 and 516; similarly, second processor 520 includes interface circuits 524 and 526. Processors 510 and 520 may exchange information via the interface 502 using interface circuits 516, 526. IMCs 512 and 522 couple the processors 510, 520 to respective memories, namely a memory 530 and a memory 540, which may be portions of main memory locally attached to the respective processors.

Processors 510, 520 may each exchange information with a network interface (NW I/F) 550 via individual interfaces 511, 521 using interface circuits 514, 556, 524, 558. The network interface 550 (e.g., one or more of an interconnect, bus, and/or fabric, and in some examples is a chipset) may optionally exchange information with a coprocessor 560 via an interface circuit 552. In some examples, the coprocessor 560 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 510, 520 or outside of both processors, yet connected with the processors via an interface such as P-P interconnect, such that either or both processors' local cache information may be stored in the shared cache if a processor is placed into a low power mode.

Network interface 550 may be coupled to a first interface 562 via interface circuit 554. In some examples, first interface 562 may be an interface such as a Peripheral Component Interconnect (PCI) interconnect, a PCI Express interconnect or another I/O interconnect. In some examples, first interface 562 is coupled to a power control unit (PCU) 563, which may include circuitry, software, and/or firmware to perform power management operations with regard to the processors 510, 520 and/or co-processor 560. PCU 563 provides control information to a voltage regulator (not shown) to cause the voltage regulator to generate the appropriate regulated voltage. PCU 563 also provides control information to control the operating voltage generated. In various examples, PCU 563 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 563 is illustrated as being present as logic separate from the processor 510 and/or processor 520. In other cases, PCU 563 may execute on a given one or more of cores (not shown) of processor 510 or 520. In some cases, PCU 563 may be implemented as a microcontroller (dedicated or general-purpose) or other control logic configured to execute its own dedicated power management code, sometimes referred to as P-code. In yet other examples, power management operations to be performed by PCU 563 may be implemented externally to a processor, such as by way of a separate power management integrated circuit (PMIC) or another component external to the processor. In yet other examples, power management operations to be performed by PCU 563 may be implemented within BIOS or other system software.

Various I/O devices 564 may be coupled to first interface 562, along with a bus bridge 565 which couples first interface 562 to a second interface 570. In some examples, one or more additional processor(s) 566, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 562. In some examples, second interface 570 may be a low pin count (LPC) interface. Various devices may be coupled to second interface 570 including, for example, a keyboard and/or mouse 572, communication devices 573 and storage circuitry 574. Storage circuitry 574 may be one or more non-transitory machine-readable storage media as described below, such as a disk drive or other mass storage device which may include instructions/code and data 575 and may implement the storage 16 in some examples. Further, an audio I/O 576 may be coupled to second interface 570. Note that other architectures than the point-to-point architecture described above are possible. For example, instead of the point-to-point architecture, a system such as multiprocessor system 500 may implement a multi-drop interface or other such architecture.

Example Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

FIG. 6 illustrates a block diagram of an example processor and/or SoC 600 that may have one or more cores and an integrated memory controller. For instance, the processor 600 may include a single core 602(A), system agent unit circuitry 610, and a set of one or more interface controller unit(s) circuitry 616. In addition or alternatively, the processor 600 may include multiple cores 602(A)-(N), a set of one or more integrated memory controller unit(s) circuitry 614 in the system agent unit circuitry 610, and special purpose logic 608, as well as a set of one or more interface controller unit(s) circuitry 616. The processor 600 may be one of the processors 510 or 520, or co-processor 560 or 566 of FIG. 5.

Thus, different implementations of the processor 600 may include: 1) a CPU with the special purpose logic 608 being integrated graphics and/or scientific (throughput) logic (which may include one or more cores, not shown), and the cores 602(A)-(N) being one or more general purpose cores (e.g., general purpose in-order cores, general purpose out-of-order cores, or a combination of the two); 2) a coprocessor with the cores 602(A)-(N) being a large number of special purpose cores intended primarily for graphics and/or scientific (throughput); and 3) a coprocessor with the cores 602(A)-(N) being a large number of general purpose in-order cores. Thus, the processor 600 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor 600 may be implemented on one or more chips, e.g., as part of a processor package. The processor 600 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 604(A)-(N) within the cores 602(A)-(N), a set of one or more shared cache unit(s) circuitry 606, and external memory (not shown) coupled to the set of integrated memory controller unit(s) circuitry 614. The set of one or more shared cache unit(s) circuitry 606 may include one or more mid-level caches, such as level 2 (L2), level 3 (L3), level 4 (L4), or other levels of cache, such as an LLC, and/or combinations thereof. While in some examples interface network circuitry 612 (e.g., a ring interconnect) interfaces the special purpose logic 608 (e.g., integrated graphics logic), the set of shared cache unit(s) circuitry 606, and the system agent unit circuitry 610, alternative examples use any number of well-known techniques for interfacing such units. In some examples, coherency is maintained between one or more of the shared cache unit(s) circuitry 606 and cores 602(A)-(N). In some examples, interface controller unit(s) circuitry 616 couple the cores 602 to one or more other devices 618 such as one or more I/O devices, storage, one or more communication devices (e.g., wireless networking, wired networking, etc.), etc.

In one embodiment, the shared cache unit(s) 606 is a large monolithic LLC (e.g., an L3 cache) that is shared across all cores and IO in processor package 600. Accordingly, the processor 600 may be referred to as a “monolithic processor.” Also, one or more of the I/O devices use DTC IO to write to the shared cache unit(s) 606. Also, the processor 600 includes a caching agent 615 which uses techniques like those described above with regard to caching agent 36 of FIG. 1 to create and manage one or more FTR partitions in shared cache unit(s) 606. In one embodiment, the processor 600 includes an uncore 620, and the caching agent 615 is implemented as part of the uncore 620. As illustrated, the uncore may also include the interface network circuitry 612, the system agent 610, and the shared cache unit(s) 606. In particular, in one embodiment, the interface network circuitry 612 implements a mesh interconnect which includes multiple stations or stops to interface with different tiles, and the shared cache unit(s) 606 includes cache slices that are distributed across those mesh stops. The caching agent 615 may also include parts that are distributed across those mesh stops. Thus, the caching agent 615 may be distributed across the mesh, along with each cache slice. The integrated memory controller unit(s) 614 may also be distributed, connecting to other components via some mesh stops. Accordingly, the interface network circuitry 612 may connect the cores, the cache slices, the IMCs, and various IO agents that handle the connections. However, in other embodiments, other types of interconnects may be used by processors with large monolithic shared caches and with caching agents that create and manage FTR partitions.

Alternatively, as indicated above, in other embodiments caching agents which create and manage FTR partitions may be implemented within a disaggregated processor that includes a core cluster and an IO cluster that is separate from the core cluster.

Referring again to FIG. 6, in some examples, one or more of the cores 602(A)-(N) are capable of multi-threading. The system agent unit circuitry 610 includes those components coordinating and operating cores 602(A)-(N). The system agent unit circuitry 610 may include, for example, power control unit (PCU) circuitry and/or display unit circuitry (not shown). The PCU may be or may include logic and components needed for regulating the power state of the cores 602(A)-(N) and/or the special purpose logic 608 (e.g., integrated graphics logic). The display unit circuitry is for driving one or more externally connected displays.

The cores 602(A)-(N) may be homogenous in terms of instruction set architecture (ISA). Alternatively, the cores 602(A)-(N) may be heterogeneous in terms of ISA; that is, a subset of the cores 602(A)-(N) may be capable of executing an ISA, while other cores may be capable of executing only a subset of that ISA or another ISA.

Example Core Architectures—In-order and out-of-order core block diagram.

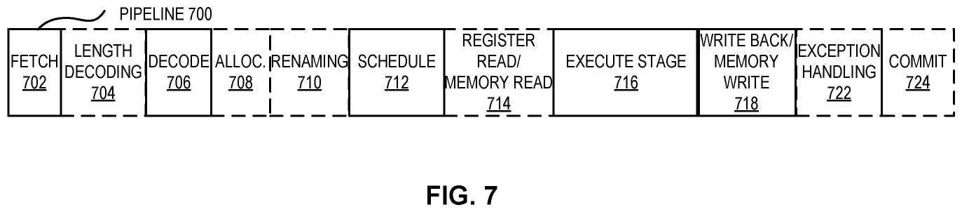

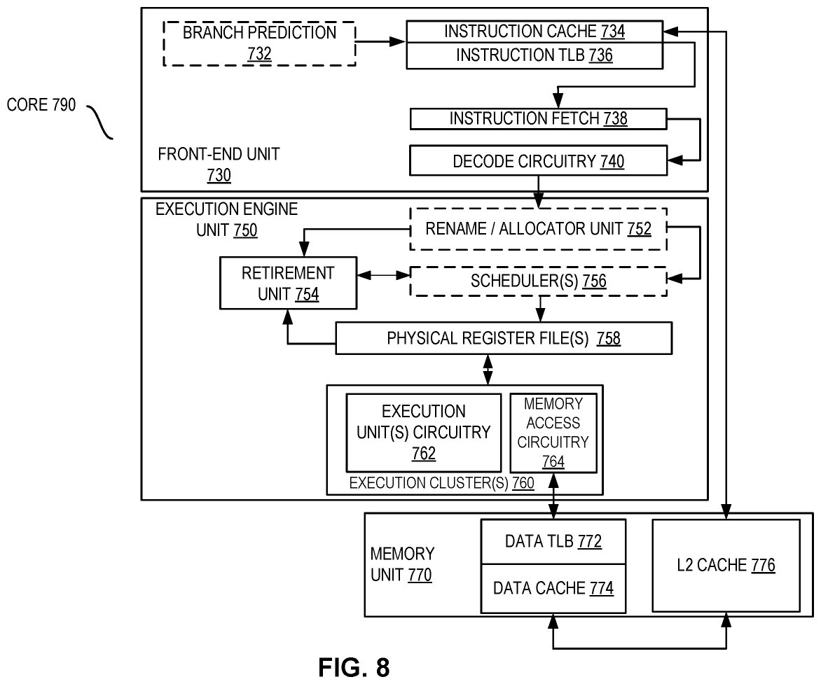

FIG. 7 is a block diagram illustrating both an example in-order pipeline and an example register renaming, out-of-order issue/execution pipeline according to examples. FIG. 8 is a block diagram illustrating both an example in-order architecture core and an example register renaming, out-of-order issue/execution architecture core to be included in a processor according to examples. The solid lined boxes in FIGS. 7-8 illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 7, a processor pipeline 700 includes a fetch stage 702, an optional length decoding stage 704, a decode stage 706, an optional allocation (Alloc) stage 708, an optional renaming stage 710, a schedule (also known as a dispatch or issue) stage 712, an optional register read/memory read stage 714, an execute stage 716, a write back/memory write stage 718, an optional exception handling stage 722, and an optional commit stage 724. One or more operations can be performed in each of these processor pipeline stages. For example, during the fetch stage 702, one or more instructions are fetched from instruction memory, and during the decode stage 706, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 706 and the register read/memory read stage 714 may be combined into one pipeline stage. In one example, during the execute stage 716, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 8 may implement the pipeline 700 as follows: 1) the instruction fetch circuitry 738 performs the fetch and length decoding stages 702 and 704; 2) the decode circuitry 740 performs the decode stage 706; 3) the rename/allocator unit circuitry 752 performs the allocation stage 708 and renaming stage 710; 4) the scheduler(s) circuitry 756 performs the schedule stage 712; 5) the physical register file(s) circuitry 758 and the memory unit circuitry 770 perform the register read/memory read stage 714; the execution cluster(s) 760 perform the execute stage 716; 6) the memory unit circuitry 770 and the physical register file(s) circuitry 758 perform the write back/memory write stage 718; 7) various circuitry may be involved in the exception handling stage 722; and 8) the retirement unit circuitry 754 and the physical register file(s) circuitry 758 perform the commit stage 724.

FIG. 8 shows a processor core 790 including front-end unit circuitry 730 coupled to execution engine unit circuitry 750, and both are coupled to memory unit circuitry 770. The core 790 may be a reduced instruction set architecture computing (RISC) core, a complex instruction set architecture computing (CISC) core, a very long instruction word (VLIW) core, or a hybrid or alternative core type. As yet another option, the core 790 may be a special-purpose core, such as, for example, a network or communication core, compression engine, coprocessor core, general purpose computing graphics processing unit (GPGPU) core, graphics core, or the like.

The front-end unit circuitry 730 may include branch prediction circuitry 732 coupled to instruction cache circuitry 734, which is coupled to an instruction translation lookaside buffer (TLB) 736, which is coupled to instruction fetch circuitry 738, which is coupled to decode circuitry 740. In one example, the instruction cache circuitry 734 is included in the memory unit circuitry 770 rather than the front-end circuitry 730. The decode circuitry 740 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 740 may further include address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 740 may be implemented using various different mechanisms. Examples of suitable mechanisms include, but are not limited to, look-up tables, hardware implementations, programmable logic arrays (PLAs), microcode read only memories (ROMs), etc. In one example, the core 790 includes a microcode ROM (not shown) or other medium that stores microcode for certain macroinstructions (e.g., in decode circuitry 740 or otherwise within the front-end circuitry 730). In one example, the decode circuitry 740 includes a micro-operation (micro-op) or operation cache (not shown) to hold/cache decoded operations, micro-tags, or micro-operations generated during the decode or other stages of the processor pipeline 700. The decode circuitry 740 may be coupled to rename/allocator unit circuitry 752 in the execution engine circuitry 750.

The execution engine circuitry 750 includes the rename/allocator unit circuitry 752 coupled to retirement unit circuitry 754 and a set of one or more scheduler(s) circuitry 756. The scheduler(s) circuitry 756 represents any number of different schedulers, including reservations stations, central instruction window, etc. In some examples, the scheduler(s) circuitry 756 can include arithmetic logic unit (ALU) scheduler/scheduling circuitry, ALU queues, address generation unit (AGU) scheduler/scheduling circuitry, AGU queues, etc. The scheduler(s) circuitry 756 is coupled to the physical register file(s) circuitry 758. Each of the physical register file(s) circuitry 758 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 758 includes vector registers unit circuitry, writemask registers unit circuitry, and scalar register unit circuitry. These register units may provide architectural vector registers, vector mask registers, general-purpose registers, etc. The physical register file(s) circuitry 758 is coupled to the retirement unit circuitry 754 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 754 and the physical register file(s) circuitry 758 are coupled to the execution cluster(s) 760. The execution cluster(s) 760 includes a set of one or more execution unit(s) circuitry 762 and a set of one or more memory access circuitry 764. The execution unit(s) circuitry 762 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 756, physical register file(s) circuitry 758, and execution cluster(s) 760 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 764). It should also be understood that where separate pipelines are used, one or more of these pipelines may be out-of-order issue/execution and the rest in-order.

In some examples, the execution engine unit circuitry 750 may perform load store unit (LSU) address/data pipelining to an Advanced Microcontroller Bus (AMB) interface (not shown), and address phase and writeback, data phase load, store, and branches.

The set of memory access circuitry 764 is coupled to the memory unit circuitry 770, which includes data TLB circuitry 772 coupled to data cache circuitry 774 coupled to level 2 (L2) cache circuitry 776. In one example, the memory access circuitry 764 may include load unit circuitry, store address unit circuitry, and store data unit circuitry, each of which is coupled to the data TLB circuitry 772 in the memory unit circuitry 770. The instruction cache circuitry 734 is further coupled to the level 2 (L2) cache circuitry 776 in the memory unit circuitry 770. In one example, the instruction cache 734 and the data cache 774 are combined into a single instruction and data cache (not shown) in L2 cache circuitry 776, level 3 (L3) cache circuitry (not shown), and/or main memory. The L2 cache circuitry 776 is coupled to one or more other levels of cache and eventually to a main memory.

The core 790 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 790 includes logic to support a packed data instruction set architecture extension (e.g., AVX1, AVX2), thereby allowing the operations used by many multimedia applications to be performed using packed data.

Example Execution Unit(s) Circuitry.

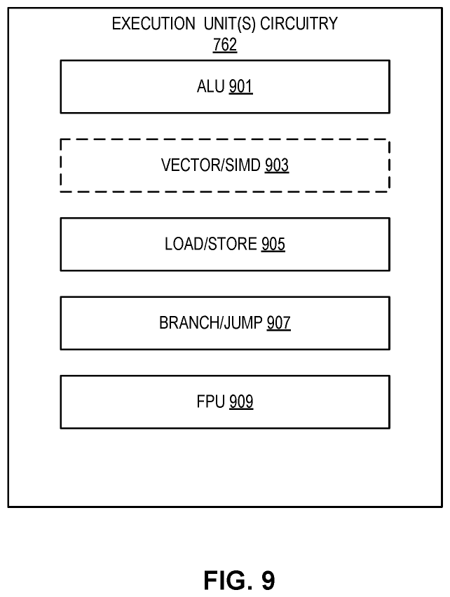

FIG. 9 illustrates examples of execution unit(s) circuitry, such as execution unit(s) circuitry 762 of FIG. 8. As illustrated, execution unit(s) circuitry 762 may include one or more ALU circuits 901, optional vector/single instruction multiple data (SIMD) circuits 903, load/store circuits 905, branch/jump circuits 907, and/or Floating-point unit (FPU) circuits 909. ALU circuits 901 perform integer arithmetic and/or Boolean operations. Vector/SIMD circuits 903 perform vector/SIMD operations on packed data (such as SIMD/vector registers). Load/store circuits 905 execute load and store instructions to load data from memory into registers or store from registers to memory. Load/store circuits 905 may also generate addresses. Branch/jump circuits 907 cause a branch or jump to a memory address depending on the instruction. FPU circuits 909 perform floating-point arithmetic. The width of the execution unit(s) circuitry 762 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

Example Register Architecture.

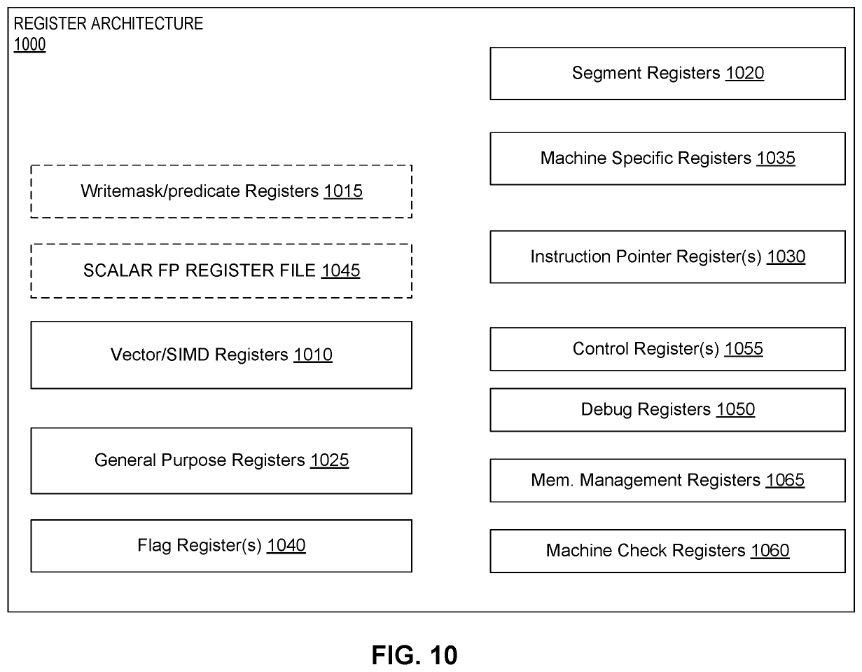

FIG. 10 is a block diagram of a register architecture 1000 according to some examples. As illustrated, the register architecture 1000 includes vector/SIMD registers 1010 that vary from 128-bit to 1,024 bits width. In some examples, the vector/SIMD registers 1010 are physically 512-bits and, depending upon the mapping, only some of the lower bits are used. For example, in some examples, the vector/SIMD registers 1010 are ZMM registers which are 512 bits: the lower 256 bits are used for YMM registers, and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 1000 includes writemask/predicate registers 1015. For example, in some examples, there are 8 writemask/predicate registers (sometimes called k0 through k7) that are each 16-bit, 32-bit, 64-bit, or 128-bit in size. Writemask/predicate registers 1015 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 1015 corresponds to a data element position of the destination. In other examples, the writemask/predicate registers 1015 are scalable and consists of a set number of enable bits for a given vector element (e.g., 8 enable bits per 64-bit vector element).

The register architecture 1000 includes a plurality of general-purpose registers 1025. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 1000 includes scalar floating-point (FP) register file 1045 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 1040 (e.g., EFLAGS, RFLAGS, etc.) store status and control information for arithmetic, compare, and system operations. For example, the one or more flag registers 1040 may store condition code information such as carry, parity, auxiliary carry, zero, sign, and overflow. In some examples, the one or more flag registers 1040 are called program status and control registers.

Segment registers 1020 contain segment points for use in accessing memory. In some examples, these registers are referenced by the names CS, DS, SS, ES, FS, and GS.

Machine specific registers (MSRs) 1035 control and report on processor performance. Most MSRs 1035 handle system-related functions and are not accessible to an application program. Machine check registers 1060 consist of control, status, and error reporting MSRs that are used to detect and report on hardware errors.

One or more instruction pointer register(s) 1030 store an instruction pointer value. Control register(s) 1055 (e.g., CR0-CR4) determine the operating mode of a processor (e.g., processor 510, 520, 560, 566, and/or 600) and the characteristics of a currently executing task. Debug registers 1050 control and allow for the monitoring of a processor or core's debugging operations.

Memory (mem) management registers 1065 specify the locations of data structures used in protected mode memory management. These registers may include a global descriptor table register (GDTR), interrupt descriptor table register (IDTR), task register, and a local descriptor table register (LDTR) register.

Alternative examples may use wider or narrower registers. Additionally, alternative examples may use more, less, or different register files and registers. The register architecture 1000 may, for example, be used in physical register file(s) circuitry 758.

### Example Embodiments

Example A1 is a method for managing cache. The method comprises, in response to receiving a first sequence of DTC write operations that are write misses to a partition in a set in a cache, writing data from the first sequence of DTC write operations to the partition in the set, wherein the partition in the set comprises W ways, W is greater than two, and the operation of writing data from the first sequence of DTC write operations to the partition in the set comprises writing data from the first sequence of DTC write operations to all W ways in the partition in the set. The method also comprises, after writing data from the first sequence of DTC write operations to all W ways in the partition in the set, and before any data from the partition in the set has been read, receiving a second sequence of at least two DTC write operations that are write misses to the partition in the set, and in response to receiving the second sequence of DTC write operations, completing the second sequence of DTC write operations while retaining the data from the first sequence of DTC write operations in at least W−1 of the ways in the partition in the set.

Example A2 is a method according to Example A1, wherein the operation of completing the second sequence of DTC write operations while retaining the data from the first sequence of DTC write operations in at least W−1 of the ways in the partition in the set comprises writing data from the second sequence of DTC write operations to memory.

Example A3 is a method according to Example A1, wherein the ways in the partition in the set comprise a staging way, and the operation of completing the second sequence of DTC write operations while retaining the data from the first sequence of DTC write operations in at least W−1 of the ways in the partition in the set comprises writing data from the second sequence of DTC write operations to the staging way.

Example A4 is a method according to Example A1, wherein the operation of writing data from the first sequence of DTC write operations to the partition in the set comprises determining whether the partition in the set comprises a way with an age attribute of FREE, and if the partition in the set comprises a way with an age attribute of FREE, (a) writing the data from the IO component to that way and (b) updating the age attribute of that way to NEW. Example A4 may also include the features of Example A2 or Example A3.

Example A5 is a method according to Example A4, wherein the operation of completing the second sequence of DTC write operations while retaining the data from the first sequence of DTC write operations in at least W−1 of the ways in the partition in the set comprises: if the partition in the set does not comprise a way with an age attribute of FREE, determining whether the partition in the set comprises a way with an age attribute of NEW; and if the partition in the set comprises a way with an age attribute of NEW, (a) updating the age attribute of that way to AGED and (b) completing an individual DTC write operation from the second sequence of DTC write operations without writing the data from that individual DTC write operation to that way.

Example A6 is a method according to Example A4, and further comprising, in response to a read operation that hits one of the ways in the partition in the set, updating the age attribute of that way to FREE. Example A6 may also include the features of Example A5.

Example A7 is a method according to Example A6, and further comprising: determining whether all of the ways in the partition in the set have age attributes at a maximum age; and in response to determining that all of the ways in the partition in the set have age attributes at the maximum age, updating the age attributes for all of the ways in the partition in the set to FREE.

Example A8 is a method according to Example A7, wherein the maximum age is based on a maximum age parameter, and the method further comprises, when the maximum age parameter specifies a maximum age of TWICE-AGED, in response to an individual DTC write operation from the second sequence of DTC write operations, if all of the ways in the partition in the set have age attributes of AGED, updating the age attribute for one of the ways in the partition in the set to TWICE-AGED.

Example A9 is a method according to Example A1, wherein the operations of (i) writing data from the first sequence of DTC write operations to the partition in the set and (ii) completing the second sequence of DTC write operations while retaining the data from the first sequence of DTC write operations in at least W−1 of the ways in the partition in the set are performed by a caching agent in a processor package in a data processing system. Also, the DTC write operations from the first and second sequences involve data from a NIC in the data processing system. Example A9 may also include the features of any one or more of Examples A2-A8.

Example B1 is a processor package comprising an integrated circuit, a cache in the integrated circuit, and a caching agent in the integrated circuit. Also, the caching agent is operable to, in response to receiving a first sequence of DTC write operations that are write misses to a partition in a set in the cache, write data from the first sequence of DTC write operations to the partition in the set, wherein the partition in the set comprises W ways, W is greater than two, and the operation of writing data from the first sequence of DTC write operations to the partition in the set comprises writing data from the first sequence of DTC write operations to all W ways in the partition in the set. In addition, the caching agent is operable to, after writing data from the first sequence of DTC write operations to all W ways in the partition in the set, and before any data from the partition in the set has been read, receive a second sequence of at least two DTC write operations that are write misses to the partition in the set, and in response to receiving the second sequence of DTC write operations, complete the second sequence of DTC write operations while retaining the data from the first sequence of DTC write operations in at least W−1 of the ways in the partition in the set.

Example B2 is a processor package according to Example B1, wherein the operation of completing the second sequence of DTC write operations while retaining the data from the first sequence of DTC write operations in at least W−1 of the ways in the partition in the set comprises writing data from the second sequence of DTC write operations to memory.

Example B3 is a processor package according to Example B1, wherein the operation of completing the second sequence of DTC write operations while retaining the data from the first sequence of DTC write operations in at least W−1 of the ways in the partition in the set comprises writing data from the second sequence of DTC write operations to a staging way among the ways in the partition in the set.

Example B4 is a processor package according to Example B1, wherein the operation of writing data from the first sequence of DTC write operations to the partition in the set comprises determining whether the partition in the set comprises a way with an age attribute of FREE, and if the partition in the set comprises a way with an age attribute of FREE, (a) writing the data from the IO component to that way and (b) updating the age attribute of that way to NEW. Example B4 may also include the features of Example B2 or Example B3.

Example B5 is a processor package according to Example B4, wherein the operation of completing the second sequence of DTC write operations while retaining the data from the first sequence of DTC write operations in at least W−1 of the ways in the partition in the set comprises: if the partition in the set does not comprise a way with an age attribute of FREE, determining whether the partition in the set comprises a way with an age attribute of NEW; and if the partition in the set comprises a way with an age attribute of NEW, (a) updating the age attribute of that way to AGED and (b) completing an individual DTC write operation from the second sequence of DTC write operations without writing the data from that individual DTC write operation to that way.

Example B6 is a processor package according to Example B4, wherein the caching agent is operable to perform further operations comprising, in response to a read operation that hits one of the ways in the partition in the set, updating the age attribute of that way to FREE. Example B6 may also include the features of Example B5.

Example B7 is a processor package according to Example B6, wherein the caching agent is operable to perform further operations comprising: determining whether all of the ways in the partition in the set have age attributes at a maximum age; and in response to determining that all of the ways in the partition in the set have age attributes at the maximum age, updating the age attributes for all of the ways in the partition in the set to FREE.

Example B8 is a processor package according to Example B7, the maximum age is based on a maximum age parameter, and the caching agent is operable to perform further operations comprising, when the maximum age parameter specifies a maximum age of TWICE-AGED, in response to an individual DTC write operation from the second sequence of DTC write operations, if all of the ways in the partition in the set have age attributes of AGED, updating the age attribute for one of the ways in the partition in the set to TWICE-AGED.

Example C1 is a data processing system comprising RAM, a processor package in communication with the RAM, an integrated circuit in the processor package, a cache in the integrated circuit, and a caching agent in the integrated circuit. Also, the caching agent is operable to, in response to receiving a first sequence of DTC write operations that are write misses to a partition in a set in the cache, writing data from the first sequence of DTC write operations to the partition in the set, wherein the partition in the set comprises W ways, W is greater than two, and the operation of writing data from the first sequence of DTC write operations to the partition in the set comprises writing data from the first sequence of DTC write operations to all W ways in the partition in the set. In addition, the caching agent is operable to, after writing data from the first sequence of DTC write operations to all W ways in the partition in the set, and before any data from the partition in the set has been read, receiving a second sequence of at least two DTC write operations that are write misses to the partition in the set, and in response to receiving the second sequence of DTC write operations, completing the second sequence of DTC write operations while retaining the data from the first sequence of DTC write operations in at least W−1 of the ways in the partition in the set.

Example C2 is a data processing system according to Example C1, wherein the operation of completing the second sequence of DTC write operations while retaining the data from the first sequence of DTC write operations in at least W−1 of the ways in the partition in the set comprises writing data from the second sequence of DTC write operations to the RAM.

Example C3 is a data processing system according to Example C1, wherein the operation of completing the second sequence of DTC write operations while retaining the data from the first sequence of DTC write operations in at least W−1 of the ways in the partition in the set comprises writing data from the second sequence of DTC write operations to a staging way among the ways in the partition in the set.

Example C4 is a data processing system according to example C1, wherein the operation of writing data from the first sequence of DTC write operations to the partition in the set comprises determining whether the partition in the set comprises a way with an age attribute of FREE, and if the partition in the set comprises a way with an age attribute of FREE, (a) writing the data from the IO component to that way and (b) updating the age attribute of that way to NEW. Example C4 may also include the features of Example C2 or Example C3.

Example C5 is a data processing system according to example C4, wherein the operation of completing the second sequence of DTC write operations while retaining the data from the first sequence of DTC write operations in at least W−1 of the ways in the partition in the set comprises: if the partition in the set does not comprise a way with an age attribute of FREE, determining whether the partition in the set comprises a way with an age attribute of NEW; and if the partition in the set comprises a way with an age attribute of NEW, (a) updating the age attribute of that way to AGED and (b) completing an individual DTC write operation from the second sequence of DTC write operations without writing the data from that individual DTC write operation to that way.

Example C6 is a data processing system according to Example C4, wherein the caching agent is operable to perform further operations comprising, in response to a read operation that hits one of the ways in the partition in the set, updating the age attribute of that way to FREE. Example C6 may also include the features of Example C5.

Example C7 is a data processing system according to Example C6, wherein the caching agent is operable to perform further operations comprising: determining whether all of the ways in the partition in the set have age attributes at a maximum age; and in response to determining that all of the ways in the partition in the set have age attributes at the maximum age, updating the age attributes for all of the ways in the partition in the set to FREE.

Example C8 is a data processing system according to Example C7, wherein the maximum age is based on a maximum age parameter, and the caching agent is operable to perform further operations comprising, when the maximum age parameter specifies a maximum age of TWICE-AGED, in response to an individual DTC write operation from the second sequence of DTC write operations, if all of the ways in the partition in the set have age attributes of AGED, updating the age attribute for one of the ways in the partition in the set to TWICE-AGED.

Example C9 is a data processing system according to Example C8, further comprising a NIC, and the DTC write operations from the first and second sequences involve data from the NIC.

Example D is a processor package comprising means to perform a method as recited in any of Examples A1-A9.

Example E is a data processing system comprising means to perform the method as recited in any of Examples A1-A9.

### CONCLUSION

References to “one example,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e. A and B, A and C, B and C, and A, B and C).

The specification and drawings are, accordingly, to be regarded in an illustrative rather than a restrictive sense. It will, however, be evident that various modifications and changes may be made thereunto without departing from the broader spirit and scope of the disclosure as set forth in the claims.

What is claimed is:

1. A processor package comprising:
an integrated circuit;
a cache in the integrated circuit; and
a caching agent in the integrated circuit, wherein the caching agent is operable to perform operations comprising:
in response to receiving a first sequence of direct-to-cache (DTC) write operations that are write misses to a partition in a set in the cache, writing data from the first sequence of DTC write operations to the partition in the set, wherein the partition in the set comprises W ways, W is greater than two, and the operation of writing data from the first sequence of DTC write operations to the partition in the set comprises writing data from the first sequence of DTC write operations to all W ways in the partition in the set; and
after writing data from the first sequence of DTC write operations to all W ways in the partition in the set, and before any data from the partition in the set has been read, receiving a second sequence of at least two DTC write operations that are write misses to the partition in the set, and in response to receiving the second sequence of DTC write operations, completing the second sequence of DTC write operations while retaining the data from the first sequence of DTC write operations in at least W−1 of the ways in the partition in the set.

2. A processor package according to claim 1, wherein the operation of completing the second sequence of DTC write operations while retaining the data from the first sequence of DTC write operations in at least W−1 of the ways in the partition in the set comprises:
writing data from the second sequence of DTC write operations to memory.

3. A processor package according to claim 1, wherein the operation of completing the second sequence of DTC write operations while retaining the data from the first sequence of DTC write operations in at least W−1 of the ways in the partition in the set comprises:
writing data from the second sequence of DTC write operations to a staging way among the ways in the partition in the set.

4. A processor package according to claim 1, wherein the operation of writing data from the first sequence of DTC write operations to the partition in the set comprises:
determining whether the partition in the set comprises a way with an age attribute of FREE; and
if the partition in the set comprises a way with an age attribute of FREE, (a) writing the data from the IO component to that way and (b) updating the age attribute of that way to NEW.

5. A processor package according to claim 4, wherein the operation of completing the second sequence of DTC write operations while retaining the data from the first sequence of DTC write operations in at least W−1 of the ways in the partition in the set comprises:
if the partition in the set does not comprise a way with an age attribute of FREE, determining whether the partition in the set comprises a way with an age attribute of NEW; and
if the partition in the set comprises a way with an age attribute of NEW, (a) updating the age attribute of that way to AGED and (b) completing an individual DTC write operation from the second sequence of DTC write operations without writing the data from that individual DTC write operation to that way.

6. A processor package according to claim 4, wherein the caching agent is operable to perform further operations comprising:
in response to a read operation that hits one of the ways in the partition in the set, updating the age attribute of that way to FREE.

7. A processor package according to claim 6, wherein the caching agent is operable to perform further operations comprising:
determining whether all of the ways in the partition in the set have age attributes at a maximum age; and
in response to determining that all of the ways in the partition in the set have age attributes at the maximum age, updating the age attributes for all of the ways in the partition in the set to FREE.

8. A processor package according to claim 7, wherein:
the maximum age is based on a maximum age parameter; and
the caching agent is operable to perform further operations comprising, when the maximum age parameter specifies a maximum age of TWICE-AGED, in response to an individual DTC write operation from the second sequence of DTC write operations, if all of the ways in the partition in the set have age attributes of AGED, updating the age attribute for one of the ways in the partition in the set to TWICE-AGED.

9. A data processing system comprising:
random access memory (RAM);
a processor package in communication with the RAM;
an integrated circuit in the processor package;
a cache in the integrated circuit; and
a caching agent in the integrated circuit, wherein the caching agent is operable to perform operations comprising:
in response to receiving a first sequence of direct-to-cache (DTC) write operations that are write misses to a partition in a set in the cache, writing data from the first sequence of DTC write operations to the partition in the set, wherein the partition in the set comprises W ways, W is greater than two, and the operation of writing data from the first sequence of DTC write operations to the partition in the set comprises writing data from the first sequence of DTC write operations to all W ways in the partition in the set; and
after writing data from the first sequence of DTC write operations to all W ways in the partition in the set, and before any data from the partition in the set has been read, receiving a second sequence of at least two DTC write operations that are write misses to the partition in the set, and in response to receiving the second sequence of DTC write operations, completing the second sequence of DTC write operations while retaining the data from the first sequence of DTC write operations in at least W−1 of the ways in the partition in the set.

10. A data processing system according to claim 9, wherein the operation of completing the second sequence of DTC write operations while retaining the data from the first sequence of DTC write operations in at least W−1 of the ways in the partition in the set comprises:
writing data from the second sequence of DTC write operations to the RAM.

11. A data processing system according to claim 9, wherein the operation of completing the second sequence of DTC write operations while retaining the data from the first sequence of DTC write operations in at least W−1 of the ways in the partition in the set comprises:
writing data from the second sequence of DTC write operations to a staging way among the ways in the partition in the set.

12. A data processing system according to claim 9, wherein the operation of writing data from the first sequence of DTC write operations to the partition in the set comprises:
determining whether the partition in the set comprises a way with an age attribute of FREE; and
if the partition in the set comprises a way with an age attribute of FREE, (a) writing the data from the IO component to that way and (b) updating the age attribute of that way to NEW.

13. A data processing system according to claim 12, wherein the operation of completing the second sequence of DTC write operations while retaining the data from the first sequence of DTC write operations in at least W−1 of the ways in the partition in the set comprises:
if the partition in the set does not comprise a way with an age attribute of FREE, determining whether the partition in the set comprises a way with an age attribute of NEW; and
if the partition in the set comprises a way with an age attribute of NEW, (a) updating the age attribute of that way to AGED and (b) completing an individual DTC write operation from the second sequence of DTC write operations without writing the data from that individual DTC write operation to that way.

14. A data processing system according to claim 12, wherein the caching agent is operable to perform further operations comprising:
in response to a read operation that hits one of the ways in the partition in the set, updating the age attribute of that way to FREE.

15. A data processing system according to claim 14, wherein the caching agent is operable to perform further operations comprising:
determining whether all of the ways in the partition in the set have age attributes at a maximum age; and
in response to determining that all of the ways in the partition in the set have age attributes at the maximum age, updating the age attributes for all of the ways in the partition in the set to FREE.

16. A data processing system according to claim 15, wherein:
the maximum age is based on a maximum age parameter; and
the caching agent is operable to perform further operations comprising, when the maximum age parameter specifies a maximum age of TWICE-AGED, in response to an individual DTC write operation from the second sequence of DTC write operations, if all of the ways in the partition in the set have age attributes of AGED, updating the age attribute for one of the ways in the partition in the set to TWICE-AGED.

17. A data processing system according to claim 9, further comprising:
a network interface controller (NIC); and
wherein the DTC write operations from the first and second sequences involve data from the NIC.

18. A method for managing cache, the method comprising:
in response to receiving a first sequence of direct-to-cache (DTC) write operations that are write misses to a partition in a set in a cache, writing data from the first sequence of DTC write operations to the partition in the set, wherein the partition in the set comprises W ways, W is greater than two, and the operation of writing data from the first sequence of DTC write operations to the partition in the set comprises writing data from the first sequence of DTC write operations to all W ways in the partition in the set; and
after writing data from the first sequence of DTC write operations to all W ways in the partition in the set, and before any data from the partition in the set has been read, receiving a second sequence of at least two DTC write operations that are write misses to the partition in the set, and in response to receiving the second sequence of DTC write operations, completing the second sequence of DTC write operations while retaining the data from the first sequence of DTC write operations in at least W−1 of the ways in the partition in the set.

19. A method according to claim 18, wherein the operation of completing the second sequence of DTC write operations while retaining the data from the first sequence of DTC write operations in at least W−1 of the ways in the partition in the set comprises:
writing data from the second sequence of DTC write operations to memory.

20. A method according to claim 18, wherein:
the ways in the partition in the set comprise a staging way; and
the operation of completing the second sequence of DTC write operations while retaining the data from the first sequence of DTC write operations in at least W−1 of the ways in the partition in the set comprises:
writing data from the second sequence of DTC write operations to the staging way.

21. A method according to claim 18, wherein the operation of writing data from the first sequence of DTC write operations to the partition in the set comprises:
determining whether the partition in the set comprises a way with an age attribute of FREE; and
if the partition in the set comprises a way with an age attribute of FREE, (a) writing the data from the IO component to that way and (b) updating the age attribute of that way to NEW.

22. A method according to claim 21, wherein the operation of completing the second sequence of DTC write operations while retaining the data from the first sequence of DTC write operations in at least W−1 of the ways in the partition in the set comprises:
if the partition in the set does not comprise a way with an age attribute of FREE, determining whether the partition in the set comprises a way with an age attribute of NEW; and
if the partition in the set comprises a way with an age attribute of NEW, (a) updating the age attribute of that way to AGED and (b) completing an individual DTC write operation from the second sequence of DTC write operations without writing the data from that individual DTC write operation to that way.

23. A method according to claim 21, further comprising:
in response to a read operation that hits one of the ways in the partition in the set, updating the age attribute of that way to FREE.

24. A method according to claim 23, further comprising:
determining whether all of the ways in the partition in the set have age attributes at a maximum age; and
in response to determining that all of the ways in the partition in the set have age attributes at the maximum age, updating the age attributes for all of the ways in the partition in the set to FREE.

25. A method according to claim 24, wherein:
the maximum age is based on a maximum age parameter; and
the method further comprises, when the maximum age parameter specifies a maximum age of TWICE-AGED, in response to an individual DTC write operation from the second sequence of DTC write operations, if all of the ways in the partition in the set have age attributes of AGED, updating the age attribute for one of the ways in the partition in the set to TWICE-AGED.
